(19) United States
(12) Patent Application Publication
(10) Pub. No.: US 2021/0208949 A1
(43) Pub. Date: Jul. 8, 2021

(54) CENTRALIZED CONTROL SERVER, LOCAL TERMINAL, DISTRIBUTED SURVEILLANCE SYSTEM, SURVEILLANCE METHOD AND STORAGE MEDIUM

(71) Applicant: NEC Corporation, Minato-ku, Tokyo (JP)

(72) Inventor: Shashank BIJWE, Tokyo (JP)

(73) Assignee: NEC Corporation, Minato-ku, Tokyo (JP)

(21) Appl. No.: 16/068,725

(22) PCT Filed: Jan. 29, 2016
(86) PCT No.: PCT/JP2016/000472

§ 371 Date: Jul. 9, 2018

(51) Int. Cl. G06F 9/50; H04N 7/18

(52) U.S. Cl. CPC G06F 9/5077; G06F 9/505; G06F 2209/5019; G06F 9/5044; G06F 2209/5021; H04N 7/181

(57) ABSTRACT

Disclosed is that centralized control server communicatively coupled with a plurality of local terminals, allows resources of the terminals to be used efficiently with sharing resources among the terminals. The centralized control server includes: information gathering unit that gathers information including current available computing resources and weight values from the plurality of local terminals, the weight value representing current processing demand at the local terminal; decision unit that calculates a resource requirement at each local terminal based on the weight value thereof, and calculates a gap between the resource requirement calculated and the current available computing resource gathered with the information gathering unit at each local terminal; and resource reservation unit that reserves an additional computing resource for a local terminal having a widest gap among the plurality of local terminals from another local terminal with a narrowest gap among the plurality of local terminals.

### TECHNICAL FIELD

The present invention relates to surveillance technology, such as a centralized control server for monitoring specific locations.

### BACKGROUND ART

A typical video surveillance system consists of number of video cameras connected to the video analysis server through wired or wireless network. The video cameras are placed at various locations in such a way, so as to monitor the intended site such as a building, metro station, airport etc. Different video analysis software tools running inside video analysis server analyze the video stream data coming from video cameras in real time and identify the unusual activities automatically. Such unusual activities are informed to concerned authority through alarms or display notifications so as to help them take suitable actions. The recorded video is also stored locally in storage servers so as to help track suspects after the incidents have happened and for various analysis purposes in non-real time applications.

PTL 1 discloses a system and method of associating video cameras with respective video servers. This system allocates video cameras automatically to video servers and in case of failure of video server, reallocates video cameras associated with failed server to other working video servers.

PTL2 discloses a technology that a monitor server automatically manages connected monitor terminals by watching the number of cameras connected to the terminals. The server monitors a capacity of the video source information of each camera to check the number of increase or decrease of the camera.

PTL3 discloses a technology that the monitoring camera performs monitoring processing and counting processing of persons. The accuracy of monitoring and counting processing is changed according to the count result.

PTL4 discloses a technology that a surveillance device sets a degree of detail when the surveillance information of the object to be monitored is acquired on the basis of a present state and a sensor signal. The surveillance device sets a different resolution in accordance with a plurality of states to the same sensor signal.

In addition, PTLS discloses related technology.

### CITATION LIST

### Patent Literature

[PTL 1] U.S. Unexamined Patent Application Publication No.2011-149080

[PTL 2] Japanese Unexamined Patent Application Publication No. 2008-113376

[PTL 3] Japanese Unexamined Patent Application Publication No. 2005-346261

[PTL 4] Japanese Unexamined Patent Application Publication No. 2005-65238

[PTL 5] Japanese Unexamined Patent Application Publication No. Hei 5 (1993)-143819

### SUMMARY OF INVENTION

### Technical Problem

With the advancement in the intelligence of video analysis software tools, more processing power and resource are required. Processing power and resource requirements of such tools also vary hugely over the time. However, the fixed capacity video analysis servers allocated to video cameras, such as shown in PTL 1-4 cannot adapt to such varying demands and leads to delay in identifying critical events or completely missing important events. In PTL 1-4, because of limited utilizable resources, the terminals have to adjust the use of resources, for example, by lowering the resolution of the unimportant image.

However, the limited resources become insufficient eventually when monitoring a very crowded place or monitoring such a crowded place for a long time. One way to solve the shortage of resources is adding more resources. However this way is costly. To add this point, there are a terminal whose resources are frequently used and another terminal whose resources are not frequently used. It is inefficient that increasing the not frequently used resources without any condition.

The present invention is made in view of the above mentioned problems. An object of the present invention is to provide a technique that the resources of terminals can be used efficiently with sharing resources among themselves.

### Solution to Problem

In order to solve the above-mentioned problem, a first exemplary aspect of the present invention is a control server communicatively coupled with a plurality of local terminals, including:

an information gathering unit that gathers information including current available computing resources and weight values from the plurality of local terminals, the weight value representing current processing demand at the local terminal;

a decision unit that calculates a resource requirement at each local terminal based on the weight value thereof, and calculates a gap between the resource requirement calculated and the current available computing resource gathered with the information gathering unit at each local terminal; and

a resource reservation unit that reserves an additional computing resource for a local terminal having a widest gap among the plurality of local terminals from another local terminal with a narrowest gap among the plurality of local terminals.

A second exemplary aspect of the present invention is a local terminal communicatively coupled with a control server, including;

a weight assignment unit which decides a criticality level by monitoring a location allocated to the local terminal and assigns a weight value of the local terminal based on the criticality level; and

an analysis unit which analyses result of the monitoring by using computing resources assigned based on the weight value and detects an event therein to generate an alarm according to the severity of the event.

A third exemplary aspect of the present invention is a distributed surveillance system, including:

the control server according to the above description; and

a plurality of the local terminals according to the above description, wherein,

the control server assigns the computing resources among the plurality of the local terminals depending on the weight values thereof.

A fourth exemplary aspect of the present invention is a surveillance method for a control server communicatively coupled with a plurality of local terminals, including:

gathering information including current available computing resources and weight values from the plurality of local terminals, the weight value representing current processing demand at the local terminal;

calculating a resource requirement at each local terminal based on the weight value thereof, and calculating a gap between the resource requirement calculated and the current available computing resource gathered with the information gathering unit at each local terminal; and

reserving an additional computing resource for a local terminal having a widest gap among the plurality of local terminals from another local terminal with a narrowest gap among the plurality of local terminals.

A fifth exemplary aspect of the present invention is a computer-readable storage medium storing surveillance program for a control server communicatively coupled with a plurality of local terminals to perform processes, the processes including:

gathering information including current available computing resources and weight values from the plurality of local terminals, the weight value representing current processing demand at the local terminal;

calculating a resource requirement at each local terminal based on the weight value thereof, and calculating a gap between the resource requirement calculated and the current available computing resource gathered with the information gathering unit at each local terminal; and

reserving an additional computing resource for a local terminal having a widest gap among the plurality of local terminals from another local terminal with a narrowest gap among the plurality of local terminals.

A sixth exemplary aspect of the present invention is a surveillance method for a local terminal communicatively coupled with a control server, including;

deciding a criticality level by monitoring a location allocated to the local terminal to assign a weight value of the local terminal based on the criticality level; and

analyzing result of the monitoring by using computing resources assigned based on the weight value and detects an event therein to generate an alarm according to the severity of the event.

A seventh exemplary aspect of the present invention is a computer-readable storage medium storing surveillance program that causes a local terminal communicatively coupled with a control server to perform processes, the processes including;

deciding a criticality level by monitoring a location allocated to the local terminal to assign a weight value of the local terminal based on the criticality level; and

analyzing result of the monitoring by using computing resources assigned based on the weight value and detects an event therein to generate an alarm according to the severity of the event.

### Advantageous Effects of Invention

According to the present invention, a surveillance technology such as a centralized control server can provide a technique that the resources of terminals can be used efficiently with sharing resources among themselves.

### BRIEF DESCRIPTION OF DRAWINGS

FIG. 1 is a block diagram showing an exemplary configuration of a distributed surveillance system according to a first exemplary embodiment of the present invention.

FIG. 2 is a block diagram showing an exemplary configuration of a centralized control server according to the first exemplary embodiment.

FIG. 3 is a block diagram showing an exemplary configuration of a local terminal according to the first exemplary embodiment.

FIG. 4 is a block diagram showing exemplary components of a weight assignment unit according to the first exemplary embodiment.

FIG. 5 shows an exemplary table in a weight memory.

FIG. 6 is a flowchart showing an exemplary process performed by a centralized control server.

FIG. 7 is a flowchart showing an exemplary process performed by a local terminal.

FIG. 8 is a block diagram showing an exemplary configuration of a distributed surveillance system according to a second exemplary embodiment of the present invention.

FIG. 9 is a block diagram showing an exemplary configuration of a centralized control server according to the second exemplary embodiment.

FIG. 10 is a figure showing an example of event information table in an event memory.

FIG. 11 is a block diagram showing an exemplary configuration of a local terminal according to the second exemplary embodiment.

FIG. 12 is a block diagram showing exemplary components of a weight assignment unit according to the second exemplary embodiment.

FIG. 13 is a flowchart showing an exemplary process performed by a centralized control server.

FIG. 14 is a flowchart showing an exemplary process performed by a local terminal according to the second exemplary embodiment.

FIG. 15 is a block diagram showing an exemplary configuration of a distributed surveillance system according to a third exemplary embodiment of the present invention.

FIG. 16 is a block diagram showing an exemplary configuration of a centralized control server according to the third exemplary embodiment.

FIG. 17 is a flowchart showing an exemplary process performed by a centralized control server.

FIG. 18 is a block diagram showing an exemplary configuration of a centralized control server according to a fourth exemplary embodiment.

FIG. 19 is a block diagram showing an exemplary configuration of an information processing apparatus to realize distributed surveillance systems according to exemplary embodiments of the present invention.

Skilled artisans will appreciate that elements in the figures are illustrated for simplicity and clarity and have not necessarily been drawn to scale. For example, the dimensions of some of the elements in the figures illustrating integrated circuit architecture may be exaggerated relative to other elements to help improve understanding of the present and alternate exemplary embodiments.

### DESCRIPTION OF EMBODIMENTS

Each exemplary embodiment of the present invention will be described below with reference to the drawings. The following detailed descriptions are merely exemplary in nature and are not intended to limit the invention or the application and uses of the invention. Furthermore, there is no intention to be bound by any theory presented in the preceding background of the invention or the following detailed description.

### First Exemplary Embodiment

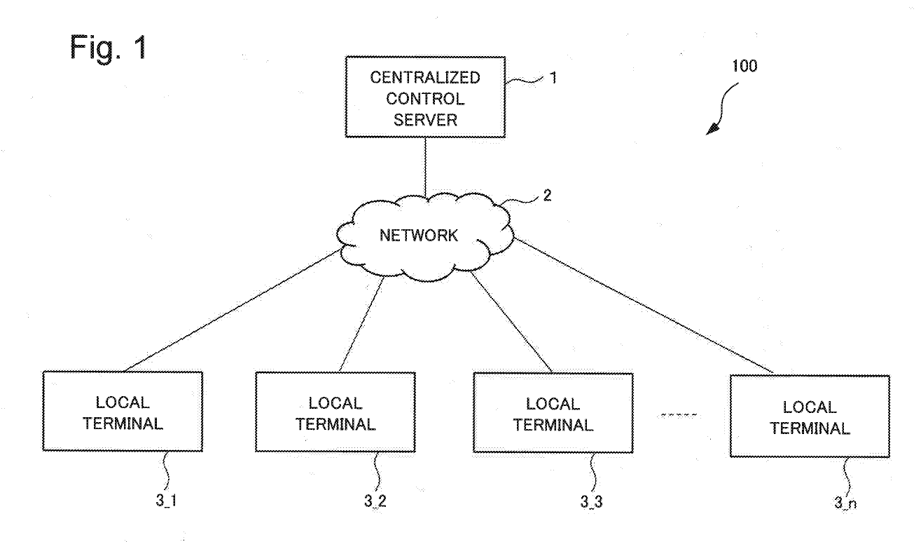

FIG. 1 is a block diagram showing an exemplary configuration of distributed surveillance system 100 according to a first exemplary embodiment. Distributed surveillance system 100 monitors intended sites of various locations relating to events, such as buildings, metro stations, an airport. Distributed surveillance system 100 ensures the detection of unusual events in surveillance videos in critical situation in short time, even when the computing resources necessary for the operation at one or more of the local terminals 3_1, 3_2, 3_3, . . . , 3_n (described as “3_1-3_n” hereinafter; n is a positive integer) are limited. To achieve this, distributed surveillance system 100 automatically arranges computing resources from the other local terminals 3_1-3_n.

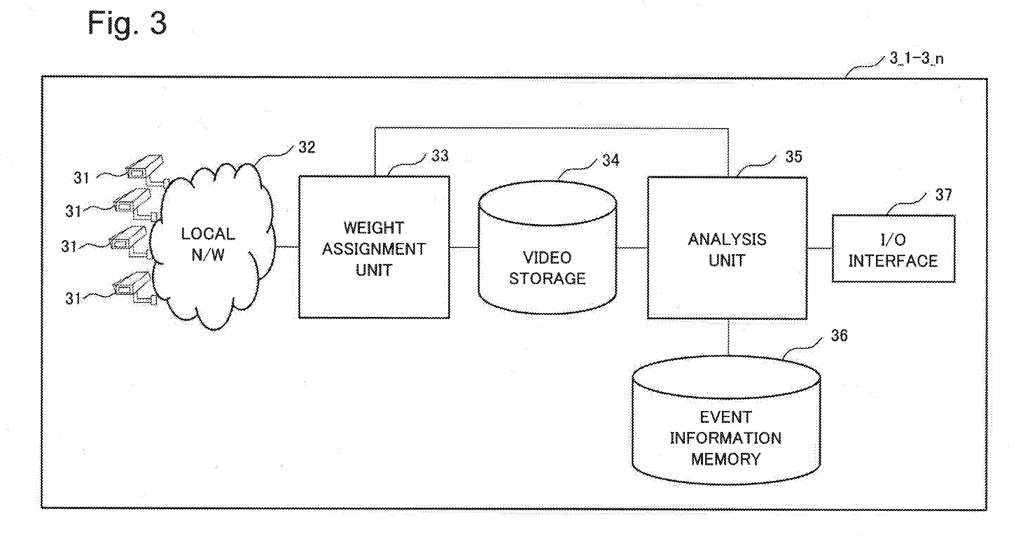

Distributed surveillance system 100 includes centralized control server 1 and local terminals 3_1-3_n. Centralized control server 1 and each of local terminals 3_1-3_n are communicable via wired or wireless network (or combination thereof, hereinafter “network 2”). Local terminals 3_1-3_n control cameras (shown in FIG. 3) placed in each surveillance area and centralized control server 1 facilitates intelligent sharing of computing resources among local terminals 3_1-3_n.

For example, at each metro station, a plurality of cameras are fixed therein, each of cameras monitors intended area respectively. On the monitoring video, specific processing is done using computing resources available at that particular metro station. Whereas, situations such as accidents, festivals, games, around these station areas result in increase in crowd. To understand these situations or identify criminals among increased crowd, video analysis software needs to perform complex and time consuming operations. This increase in processing demand needs more computing resources and available computing resources at that metro station fall short at fulfilling this increase in demand. However, such situations usually do not occur at all the stations at the same time. Computing resources at other stations remain unused and result in bad resource utilization. For example, local terminal 3a in station A (not shown) needs more resources because of rushing crowd, at that time, local terminal 3b in station B (not shown) has remaining resources because nothing special is happened. Distributed surveillance system 100 can be used at such network of metro stations in a city or a region. Each of local terminals 3_1-3_n sets up in different metro stations respectively in the embodiments described below. Local terminals 3_1-3_n autonomously detect such emergency situations and determine criticality levels of demand and computing resources therewith as weight and inform the weight (demand) to centralized control server 1. Centralized control server 1 fulfills the increase in demand at more critical metro stations, such as local terminal 3a, by reserving resources from less critical metro stations, such as local terminal 3b. Thus, distributed surveillance system 100 ensures the detection of unusual events in surveillance videos in critical situation in short time, even when the computing resources necessary for the operation at one or more of the metro stations are limited.

### (Centralized Control Server)

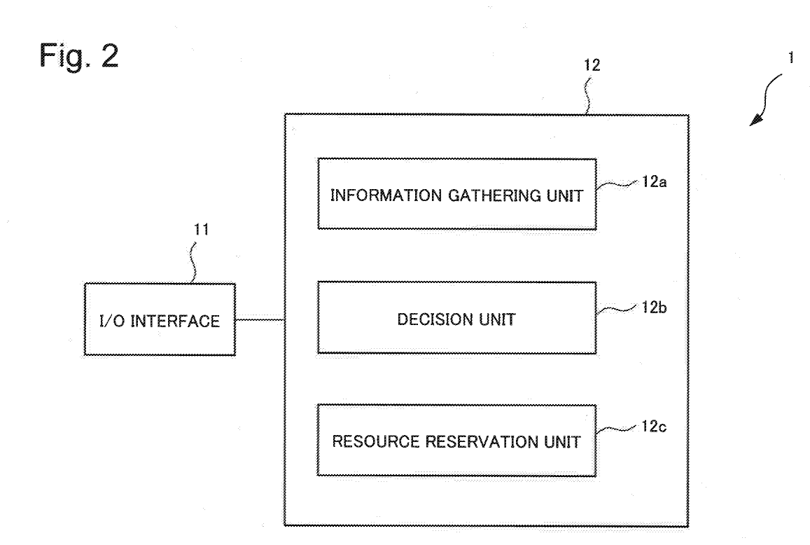

As shown in FIG. 2, centralized control server 1 includes I/O interface 11 and control unit 12. Control unit 12 realizes resource sharing between local terminals 3_1-3_n, the existing resource sharing technique is used. For example, U.S. Unexamined Patent Application Publication No. U.S. Ser. No. 11/140,429 discloses techniques to selectively off-loading workload across multiple data centers. More specifically, a portion of a workload associated with the classified user request is off-loaded to second data center to be processed, wherein the off-loading step/operation is based on administrative policies associated with one of the first data center and the second data center. In the technique, local terminals 3_1-3_n also works as a kind of accelerators for other local terminals. When a local terminal faces sudden increasing large amounts of processes and the processes are about to overflow, the server assign another local terminal as an accelerator to offload some of the processes, in other word, allow the busy local terminal to utilize the another local terminal's computing resources. Before the offloading, the server links the two terminals virtually as a temporary pair. After all processes are completed, the server delinks the pair. The server can manage the pair link not only scheduled in advance but also without previous notice.

Control unit 12 includes information gathering unit 12a, decision unit 12b and resource reservation unit 12c.

Information gathering unit 12a retrieves weight values which show criticality levels of demand at each local terminal 3_1-3_n, and collects information related to current computing resources such as CPU (Central Processing Unit) and/or memory available at each of local terminals 3_1-3_n.

Decision unit 12b determines criticality level of the local terminals 3_1-3_n based on weight values, and calculates the gap between resource demand and available resources at local terminals 3_1-3_n. Decision unit 12b arranges computing resource sharing for more critical local terminals 3_1-3_n from less critical local terminals 3_1-3_n.

Resource reservation unit 12c reserves the additional computing resources requirements for the more critical level (heavy weight value) local terminals 3_1-3_n from the less critical local terminals 3_1-3_n based on the decision unit 12b's suggestions, in order to detect the unusual events in surveillance video at critical local terminals 3_1-3_n in short time.

I/O interface 11 is communicable with other units in centralized control server 1 and network 2. For example, I/O interface 11 is connected to a display (not shown) and shows the decision made by decision unit 12b. I/O interface 11 sends and receives information and data between centralized control server 1 and local terminals 3_1-3_n.

### (Local Terminal)

As shown in FIG. 3, local terminals 3_1-3_n include cameras 31, local network 32, weight assignment unit 33, video storage 34, analysis unit 35, event information memory 36 and I/O interface 37.

Camera 31 may be any type of surveillance cameras wired or wireless, fixed and/or portable. Camera 31 is capable of monitoring the intended area at the site with sufficient resolution.

Local network 32 is wired or wireless network through which cameras 31 feed surveillance video stream for processing in weight assignment unit 33.

Weight assignment unit 33 receives the surveillance video stream via local network 32 and monitors the number of people shown in frame of cameras 31. Weight assignment unit 33 decides the critical level of the local terminal and assign the weight value accordingly.

Video storage 34 acts as a buffer for the surveillance video stream. When criticality of the particular local terminal is evaluated less criticality level (lower weight) and computing resources of that particular local terminal are being used by other more critical level local terminals, video storage 34 holds a part of the surveillance video stream of its own station and feeds analysis unit 35 accordingly so as not to lose tracking of events shown in cameras 31 of the local terminal at that particular station.

Analysis unit 35, a main unit as a video analysis software tool, analyses the surveillance video stream and detects various events therein, such as a rushing crowd, a fire and an accident. Analysis unit 35 can use the output of other sensors from weight assignment unit 33. Analysis unit 35 generates alarms according to the severity of each event and sends the alarms to I/O interface 37. Analysis unit 35 stores the events in event information memory 36.

Event information memory 36 stores detected events and relevant alarms by analysis unit 35 so as to be able to refer to the events and alarms at later times. Event information memory 36 also stores a specific video footage at when and where the events are detected.

I/O interface 37 is communicable with other units and network 2. For example, I/O interface 37 is connected to a display (not shown) and shows the alarms sent from analysis unit 35. The display enables users to access event information memory 36 for further investigations on the stored events. I/O interface 37 sends and receives information and data among centralized control server 1 and other local terminals 3_1-3_n.

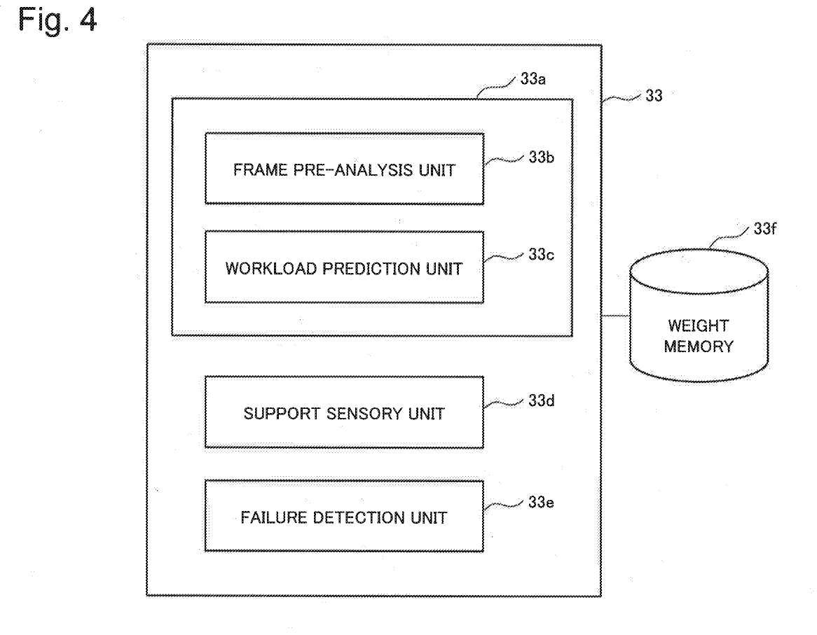

FIG. 4 shows an exemplary configuration of weight assignment unit 33. Weight assignment unit 33 includes workload estimation unit 33a, support sensory unit 33d, failure detection unit 33e. Weight assignment unit 33 connects to weight memory 33f communicatively.

Weight assignment unit 33 combines the output of workload estimation unit 33a, support sensory unit 33d and failure detection unit 33e, and calculates the weight value.

Workload estimation unit 33a includes frame pre-analysis unit 33b and workload prediction unit 33c. Workload estimation unit 33a combines the output of frame pre-analysis unit 33b and workload prediction unit 33c, to estimate the near future workload. More specifically, workload estimation unit 33a estimates the quantity of workload in terms of number of cores required for computation. Number of cores is considered as the unit of computation, thus any standard server configuration can be considered.

Frame pre-analysis unit 33b partitions the surveillance video stream in frames sent from cameras 31 and then do pre-analysis on the frames to roughly estimate the number of people in the frames. Frame pre-analysis unit 33b can hold a memory storing thresholds to determine tentative weight value based on the number of people shown in the frame.

Workload prediction unit 33c predicts required workload and resources for that based on the past workload patterns and the weight value obtained from frame pre-analysis unit 33b.

Support sensory unit 33d monitors the situation around local terminals 3_1-3_n using other sensors such as smoke detector, temperature detector, and audio detector. Support sensory unit 33d detects anomalies in other sensors' output. Support sensory unit 33d can correlate data from all the sensors to reveal the situation correctly. Support sensory unit 33d decides the criticality level, for example, in the range of {1.0, 1.1, 1.2, 1.3, . . . , 2.0}.

Failure detection unit 33e monitors for failure of critical components such as video storage 34, analysis unit 35 and event information memory 36. Failure of these critical components affects the video analysis operation at analysis unit 35 and results in loss of important events. Failure detection unit 33e detects the failure, and determines the loss of resources and accordingly increases weight value in weight assignment unit 33 so as to reserve more resources from other local terminals 3_1-3_n to compensate for the loss of critical components at its own site. Failure detection unit 33e also determines the lost compute power in terms of number of cores based on the detected failure.

Weight memory 33f stores the outputs and calculated weight values.

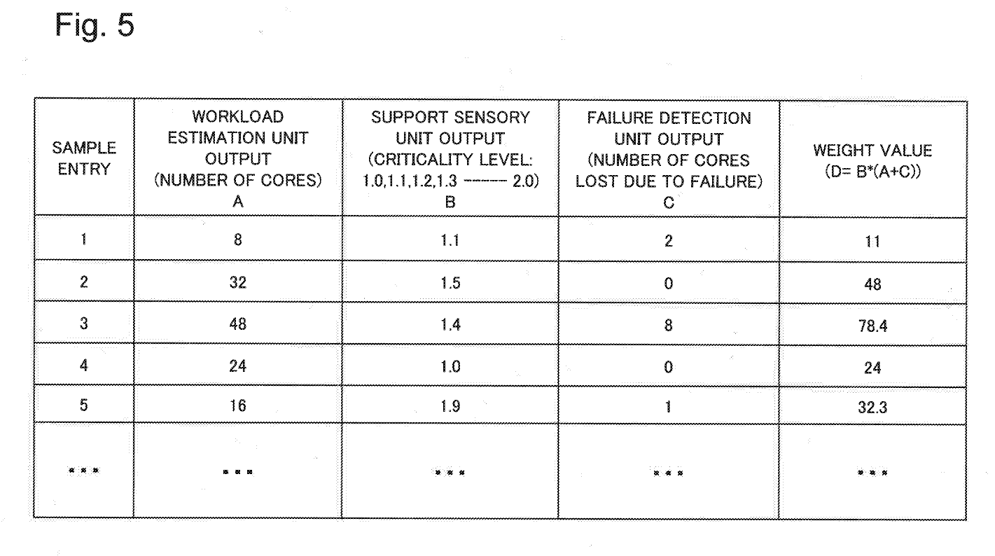

An example of calculating weight values is described below with referring to FIG. 5. Weight assignment unit 33 obtains the outputs, more specifically, a number of cores (indicated as A) from workload estimation unit 33a, a criticality level (indicated as B) from support sensory unit 33d and a number of cores lost due to failure (indicated as C) from failure detection unit 33e. Weight assignment unit 33 calculates a weight value (indicated as D) by using a formula, such as D=B*(A+C). Weight assignment unit 33 stores the outputs (A-D) in weight memory 33f. This calculation is an example, the calculation of the output values is not limited to this way. Weight assignment unit 33 send the weight value from weight memory 33f to centralized control server 1 by I/O interface 37 via network 2.

### (Operation of Distributed Surveillance System)

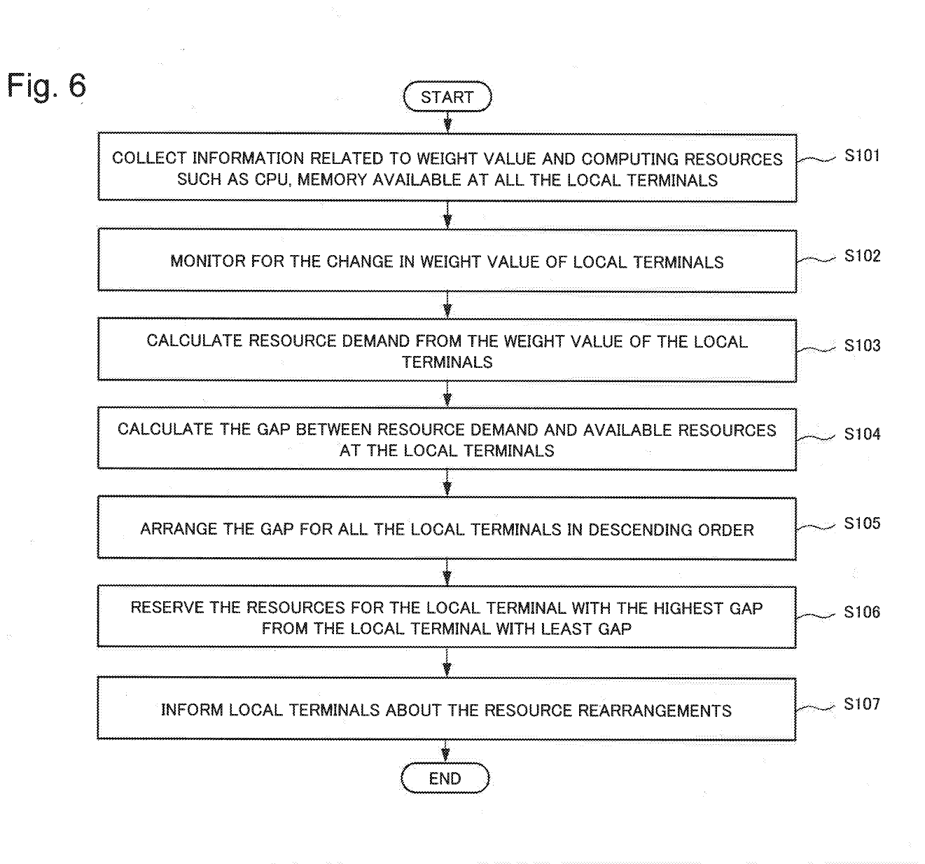

The process performed by the centralized control server 1 will be described in detail with reference to FIG. 6.

First, at step S 101, information gathering unit 12a of the centralized control server 1 collects information relating current performance environment of local terminals 3_1-3_n, such as the current weight value.

At step S 102, information gathering unit 12a monitors for the change in the weight values of local terminals 3_1-3_n by comparing the current weight value and the previous weight value. When the change in the weight values is detected, information gathering unit 12a notifies the change to decision unit 12b.

At step S 103, decision unit 12b calculates current resource demand from the received weight value of the local terminals 3_1-3_n.

At step S 104, decision unit 12b calculates the gap between the current resource demand and available resources at the local terminals 3_1-3_n. The gap shows shortage or surplus of the resource.

At step S 105, decision unit 12b arranges the gaps of all the local terminals 3_1-3_n in descending order.

At step S 106, resource reservation unit 12c reserves the resources for the local terminal with the highest gap (shortage of resources) from the local terminal with the least gap (surplus of resources).

At step S 107, resource reservation unit 12c informs the local terminals 3_1-3_n about the resource rearrangements, and rearranges the resources according to the information by adapting a virtualization resource sharing technology.

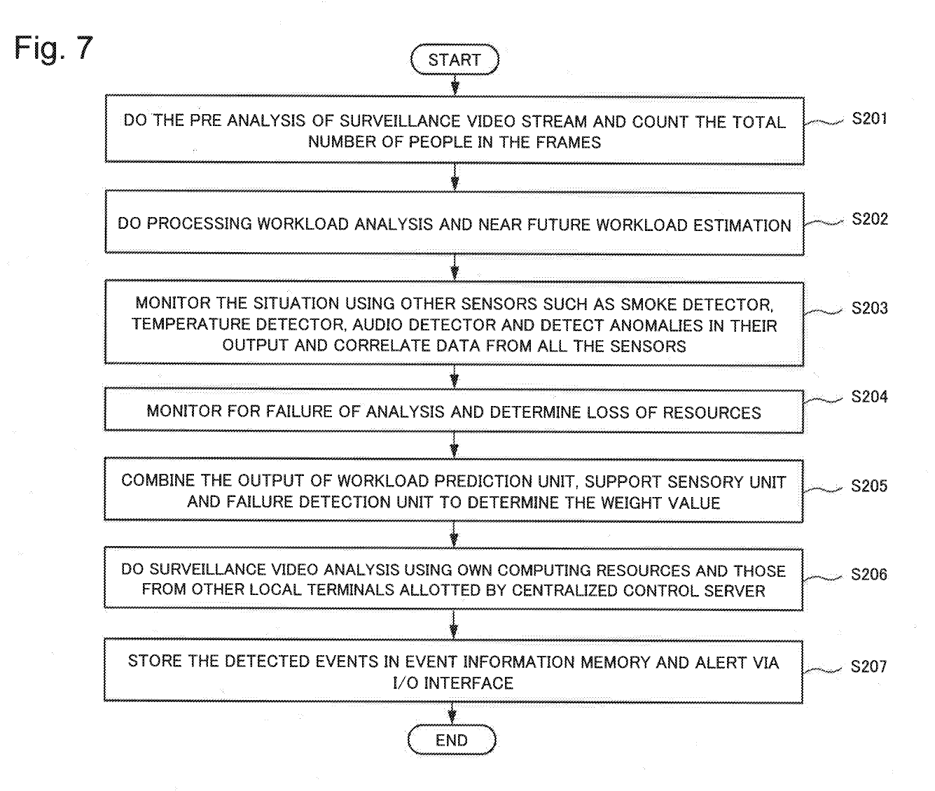

Next, the process performed by local terminals 3_1-3_n will be described in detail with reference to FIG. 7.

First, at step S 201, frame pre-analysis unit 33b does the pre analysis of surveillance video stream and counts the total number of people in the frames and estimates a tentative weight value. Frame pre-analysis unit 33b can refer to thresholds in memory to determine the tentative weight value based on the number of people shown in the frame.

At step S 202, workload prediction unit 33c does processing workload analysis and near future workload estimation. For the estimation, workload prediction unit 33c predicts required workload and necessary resources for that based on the past workload patterns and the tentative weight value obtained from frame pre-analysis unit 33b.

At step S 203, support sensory unit 33d monitors the situation using other sensors such as smoke detector, temperature detector and audio detector. Support sensory unit 33d detects anomalies in the output of other sensors. Specifically, support sensory unit 33d correlates data from all the sensors and determines a criticality level.

At step S 204, failure detection unit 33e monitors for failure of analysis at analysis unit 35 and determines loss of resources caused by the analyzing failure if the failure is detected so far.

At step S 205, weight assignment unit 33 combines the output of workload estimation unit 33a (a workload estimation such as number of cores), support sensory unit 33d (a criticality level) and failure detection unit 33e (a number of cores lost due to failure), and calculates a current weight value based on the combined output such as described above. Weight assignment unit 33 sends the calculated weight value to centralized server 1 by I/O interface 37 via network 2.

At step S 206, analysis unit 35 does the surveillance video analysis using own computing resources and those from other local terminals 3_1-3_n pre-allotted by centralized control server 1. It allows the analysis unit 35 to utilize extra computing resources and the analysis unit 35 can avoid lower the resolution of images, sent from cameras 31, for analyzing the situation.

At step S 207, analysis unit 35 stores the detected events in event information memory 36 and transmits an alert per the detected events via I/O interface 37. The alert is shown in a display to inform the alert to user (worker).

### Effect of First Exemplary Embodiment

As explained above, distributed surveillance system 100 according to the first exemplary embodiment provides a technique that the resources of terminals with resources can be used efficiently with sharing resources among themselves. Distributed surveillance system 100 can achieve this without lowering the resolution of the image taken by the terminals' cameras or adding extra resources. Distributed surveillance system 100 ensures the detection of unusual events in surveillance videos in critical situation in short time, even when the computing resources necessary for the operation at one or more of the local terminals 3_1-3_n is limited. The reason is that when a critical event and new demand for resources is detected, distributed surveillance system 100 temporary reallocates the resources from a less critical local terminal to a more critical local terminal.

### Second Exemplary Embodiment

In the first exemplary embodiment, the allocation of computing resources is decided in accordance with congestion of location at the installed local terminal (eg. metro stations) at the time. However, the congestion tends to depend on events held in the vicinity of the location (eg. a festival, a sport game). The events are predictable by obtaining the event schedule in advance. In the second exemplary embodiment, distributed surveillance system 200 will be explained that allocates computing resources by taking the event schedule into account. In distributed surveillance system 200, the number of camera connected to the local terminal can be increased or decreased depending on scale of the events.

Furthermore, increasing or decreasing the number of cameras can cope with unpredictable rushing crowd. When the local terminal detects the crowd, the local terminal informs the detection by, such as, showing an alarm on a display so as to be perceived as caution by an administrator (user). This allows the administrator to set up some portable cameras temporarily to the local terminal installation location.

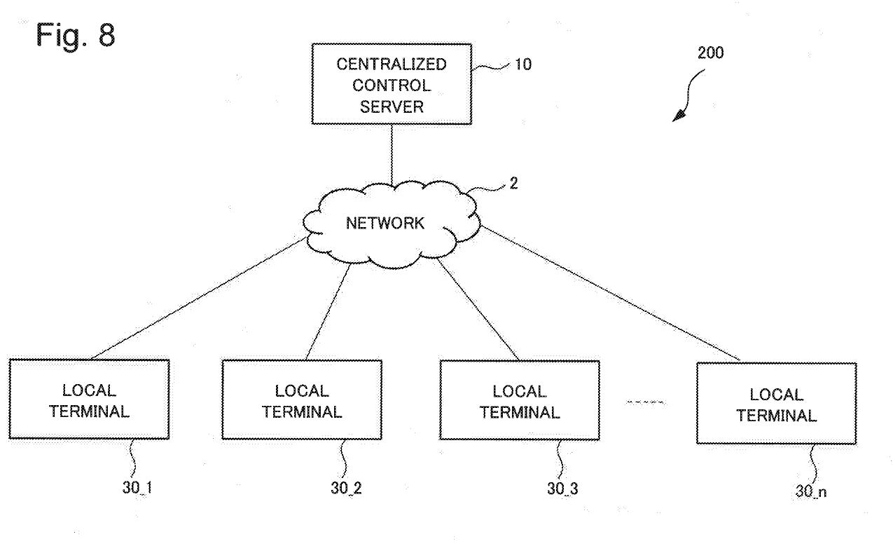

FIG. 8 is a block diagram showing an exemplary configuration of distributed surveillance system 200 according to the second exemplary embodiment. Distributed surveillance system 200 includes centralized control server 10 and local terminal 30_1-30_n.

### (Centralized Control Server)

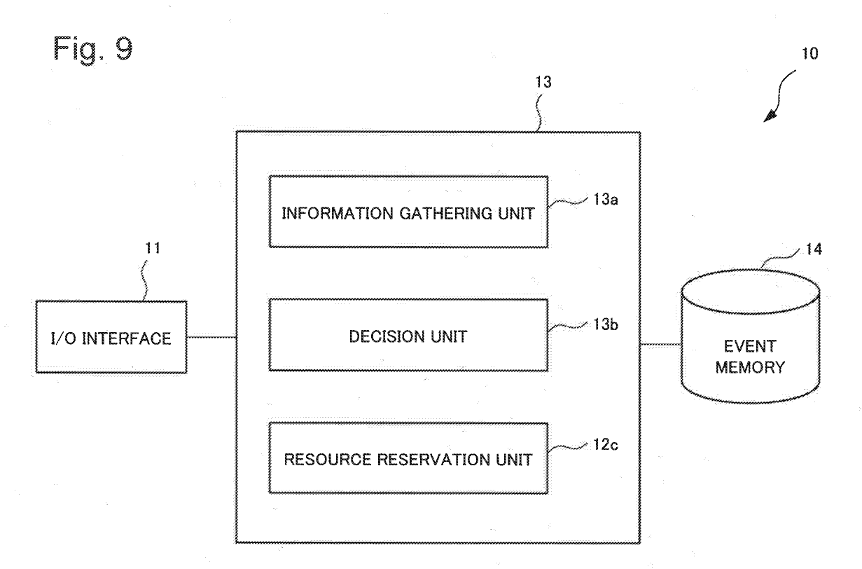

As shown in FIG. 9, centralized control server 10 includes I/O interface 11, control unit 13 and event memory 14. Control unit 13 includes information gathering unit 13a, decision unit 13b and resource reservation unit 12c. In the second exemplary embodiment, it assumes that local terminals 30_1-30_n are installed at stations respectively.

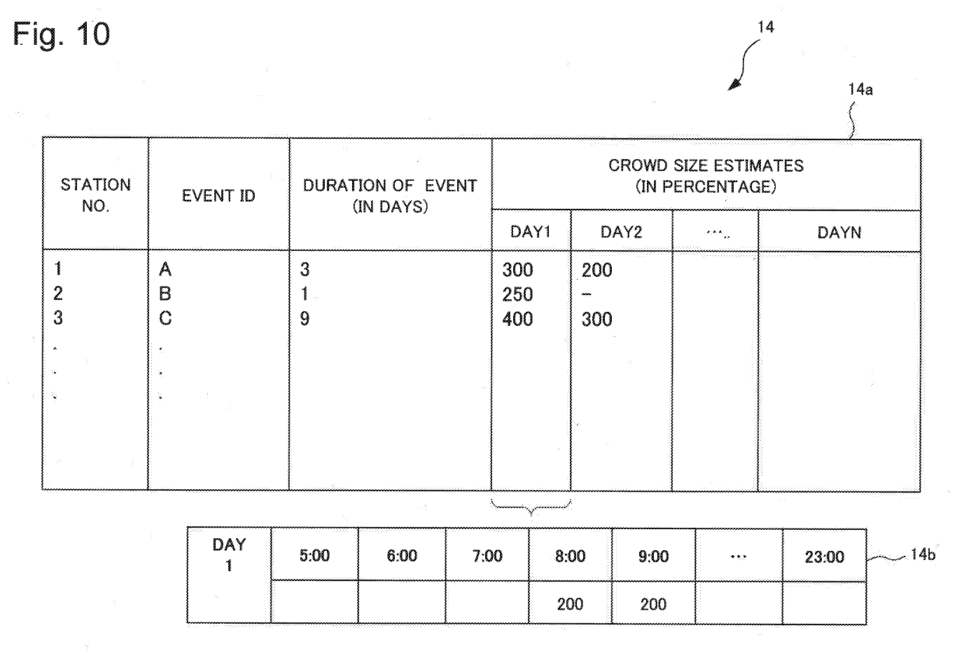

Event memory 14 stores event information table 14a shown in FIG. 10, which has information of various events happening at various locations near location of local terminals 30_1-30_n (stations). The events can be festivals, games, accident locations, buildings, tourist destinations etc., but not limited to this. Event memory 14 can be synced with outer database such as a police department database which usually records estimation of the crowd size for various events. Event information table 14a has record items such as “Station No.”, “Event ID”, “Duration of event” and “Crowd size estimates”.

“Station No.” represents the identifier of the location of each station.

“Event ID” represents the identifier of a type of each event happening at near the station.

“Duration of event” represents the number of days the particular event lasts.

“Crowd size estimates” represents the estimated rate (percentage) of increase compared to a regular day. The crowd size varies depending on the time. Thus, the estimates can be represented at predetermined time intervals in a day, such as shown in Day 1 estimates 14b in FIG. 10, or can be represented as a graph that has one axis showing the time and another axis showing the number of crowd. The estimates can be represented as calendar entries.

Information gathering unit 13a retrieves weight values of local terminals 30_1-30_n and collects current information related to number of cameras and computing resources such as CPU, memory available at each of local terminals 30_1-30_n.

Decision unit 13b determines critical level of the local terminals 30_1-30_n based on weight values. Decision unit 13b calculates the gap between resource requirement and available resources at the each of local terminals 30_1-30_n. Decision unit 13b suggests computing resource arrangements for more critical local terminals 30_1-30_n from less critical local terminals 30_1-30_n. Decision unit 13b retrieves the crowd size estimates for different time of the day from event information table 14a in event memory 14 and uses the crowd size estimates to determine the need to add or remove cameras 31 at particular local terminals 30_1-30_n.

Other units are the same as described in the first exemplary embodiment.

### (Local Terminal)

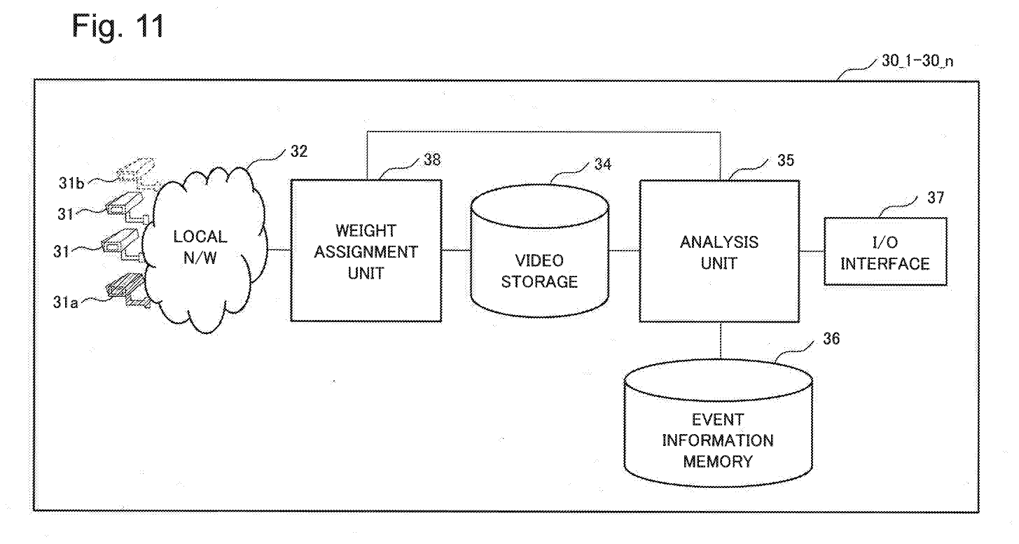

As shown in FIG. 11, each of local terminals 30_1-30_n includes cameras 31, local network 32, weight assignment unit 38, video storage 34, analysis unit 35, event information memory 36 and I/O interface 37.

Cameras 31 can be added (such as camera 31a) or removed (such as camera 31b) depending on the crowd estimates. Cameras 31 can be attached to wall or ceiling of the station temporarily, or a person who wears a cap or a vest with cameras 31 attached thereon or a robot who has the cameras 31 can sneak into the crowd. If local terminals 30_1-30_n are set in spacious or open space, a drone who carries the cameras 31 can be used.

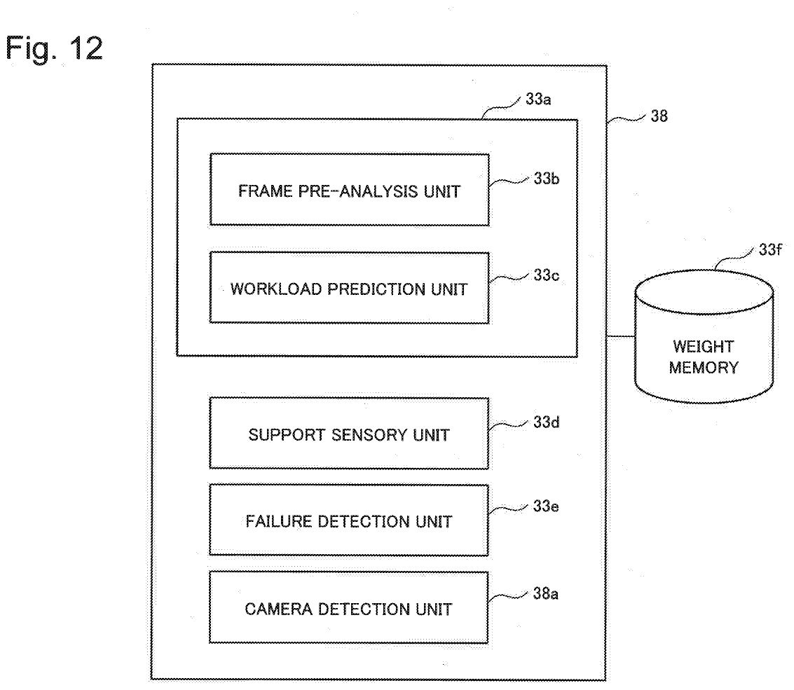

FIG. 12 shows an exemplary configuration of weight assignment unit 38. Weight assignment unit 38 includes workload estimation unit 33a, support sensory unit 33d, failure detection unit 33e and Camera detection unit 38a.

Camera detection unit 38a monitors for addition/removal of cameras 31 at the local terminals 30_1-30_n. Increase/decrease in number of cameras 31 results in corresponding increase/decrease in weight value at that particular local terminal 30_1-30_n. Camera detection unit 38a transmits the camera information which relates to the addition/removal of cameras 31 to weight assignment unit 38. Weight assignment unit 38 calculates a weight value taking the camera information into consideration.

Other units are the same as described in the first exemplary embodiment.

### (Operation of Distributed Surveillance System)

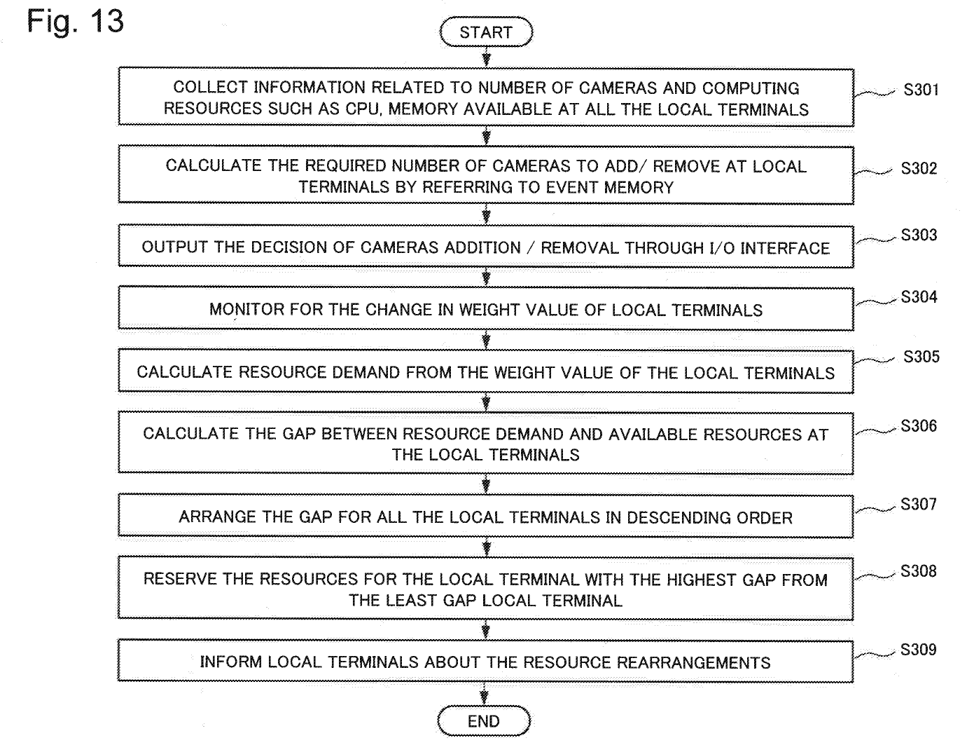

The process performed by the centralized control server 10 will be described in detail with reference to FIG. 13.

First, at step S301, information gathering unit 13a of the centralized control server 10 collects information related to number of cameras 31 and computing resources such as CPU, memory available at each of the local terminals 30_1-30_n.

At step S 302, decision unit 13b calculates the currently required number of cameras for each of local terminals 30_1-30_n by referring to the crowd size estimates from event information table 14a in event memory 14.

At step S 303, decision unit 13b outputs the decision of camera addition/removal to local terminals 30_1-30_n by I/O interface 11 via network 2. Local terminals 30_1-30_n show the decision of camera addition/ removal on the display. It allows a user (worker) of local terminals 30_1-30_n to perceive the shown information as notice, and the worker attaches or removes the cameras 31 in accordance with the notice.

Step S 304 to S 309 are the same as step S102 to S107 shown in FIG. 6 in the first exemplary embodiment.

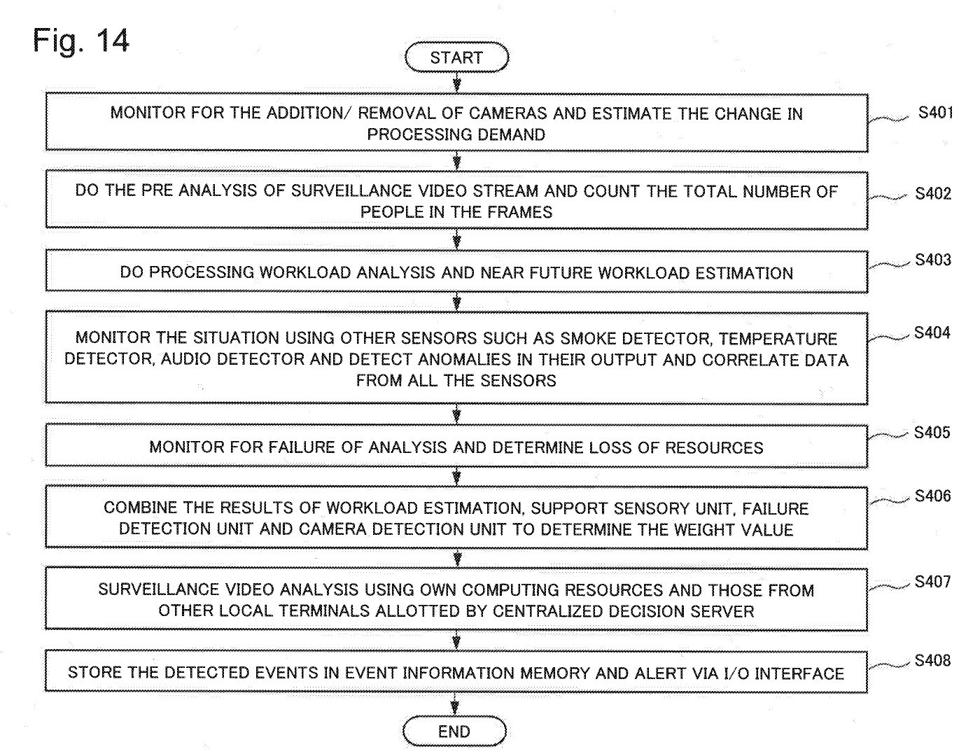

Next, the process performed at local terminals 30_1-30_n will be described in detail with reference to FIG. 14.

First, at step S 401, camera detection unit 38a monitors for the addition/removal of cameras and estimates the change in processing demand.

Step S 402 to S 405 are the same as step S 201 to S 204 shown in FIG. 7 in the first exemplary embodiment.

At step S 406, weight assignment unit 33 combines the output of workload estimation unit 33a, support sensory unit 33d, failure detection unit 33e and camera detection unit 38a and determines the weight value based on the combined output.

Step S 407 to S 408 are the same as step S 206 to S 207 shown in FIG. 7 in the first exemplary embodiment.

### Effect of Second Exemplary Embodiment

As explained above, distributed surveillance system 200 according to the second exemplary embodiment, in addition to the effect of the first exemplary embodiment, ensures the detection of unusual events in surveillance videos in critical situation in short time, even when the computing resources necessary for the operation at one or more of the local terminals 30_1-30_n are limited. The reason is that when a critical event and new demand for resources are detected, distributed surveillance system 200 temporarily reallocates the resources from a less critical local terminal to a more critical local terminal.

Furthermore, distributed surveillance system 200 makes coordinated decision and facilitates the optimal use of cameras 31 among local terminals 30_1-30_n. This results in reduction in cost of operation. distributed surveillance system 200 also understands the increase in computing resource demand for additional cameras 31 and automatically manages computing resources among different local terminals 30_1-30_n.

### Third Exemplary Embodiment

In the first and second exemplary embodiments, the total amount of computing resources is fixed. However, relating to the number of visitors at the installation site, such as stations, there exist always busy local terminals and other unbusy local terminals. In such case, the frequent temporary resource usage among the busy local terminals and the unbusy local terminals can cause deterioration in data transmission efficiency. Therefore, it is preferable to reallocate permanently more resources to the busy local terminal and fewer resources to the unbusy local terminal. This reallocation should be executed at predetermined intervals for better resource usage efficiency. In the third exemplary embodiment, a distributed surveillance system 300 for the permanent reallocation is described.

### (Centralized Control Server)

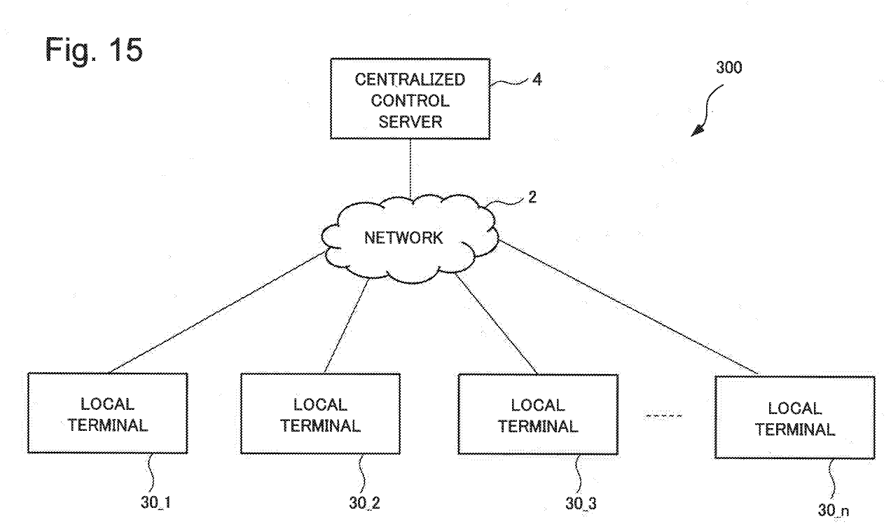

FIG. 15 is a block diagram showing an exemplary configuration of distributed surveillance system 300 according to the third exemplary embodiment. Distributed surveillance system 300 includes centralized control server 4 and local terminal 30_1-30_n.

Centralized control server 4 facilitates optimal resource planning. As the demand for more computing resources at some local terminals 30_1-30_n increases more rapidly than other local terminals 30_1-30_n according to the popularity and importance of that particular local terminals 30_1-30_n, there arises a need to temporarily reallocate the computing resources at these local terminals 30_1-30_n. Similarly there arises the demand for increase in number of cameras 31 at local terminals 30_1-30_n. Distributed surveillance system 300 calculates the optimal decision and suggests drastic rearrangement (or upgrade if necessary) in computing resources and cameras 31 at local terminals 30_1-30_n. This optimal decision leads to real time detection of events in surveillance video, efficient operation and reduction in operation costs.

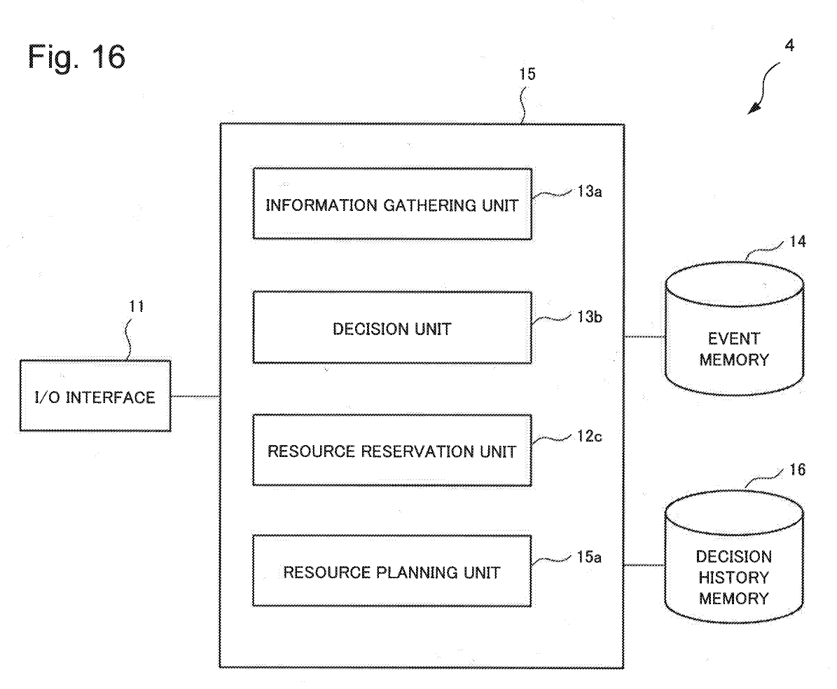

As shown in FIG. 16, centralized control server 4 includes I/O interface 11, control unit 15, event memory 14 and decision history memory 16. Control unit 15 includes information gathering unit 13a, decision unit 13b, resource reservation unit 12c and resource planning unit 15a.

Decision history memory 16 stores the decisions made by decision unit 13b about resource rearrangement such as movement of cameras 31 from some local terminals 30_1-30_n to other local terminals 30_1-30_n, such as described in the second exemplary embodiment. Decision history memory 16 also stores the decisions regarding resource sharing among local terminals 30_1-30_n.

Resource planning unit 15a analyses the decisions stored in decision history memory 16 and suggests the need to upgrade the computing resources, such as CPUs and memories, at the local terminals 30_1-30_n to satisfy the consistent increase in demand for computing resources and reduces the data movement between local terminals 30_1-30_n. Resource planning unit 15a refers to decision history memory 16 periodically and analyses the movements of cameras 31 among local terminals 30_1-30_n. Resource planning unit 15a identifies the local terminals 30_1-30_n who need to increase the number of fixed cameras 31, so as to satisfy the consistent increase in demand by those local terminals 30_1-30_n. This can reduce the frequent exchange of cameras 31 among local terminals 30_1-30_n. The demand for increasing or decreasing of resources can be correlated to the number of increased or decreased cameras.

Other units of distributed surveillance system 300 and local terminals 30_1-30_n are the same as described in the first or second exemplary embodiments.

(Operation of distributed surveillance system)

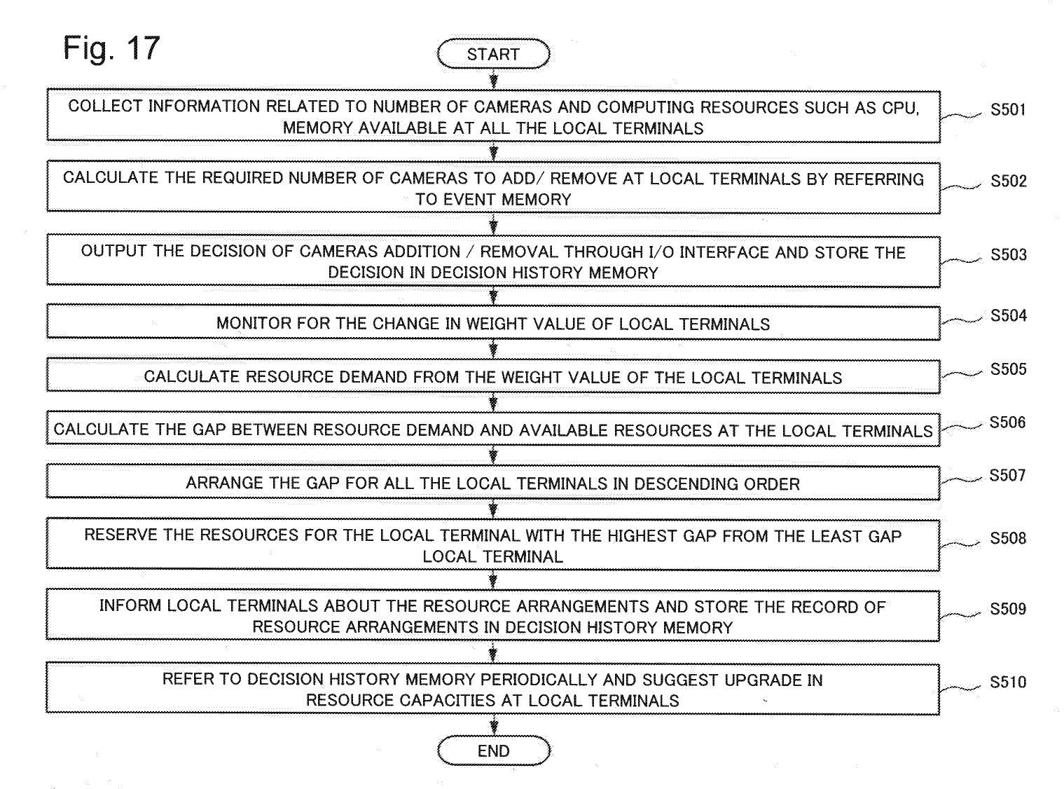

The process performed by the centralized control server 4 will be described in detail with reference to FIG. 17.

Step S501 and S502 are the same as step S301 and S302 in the second exemplary embodiment in FIG. 13.

At step S 503, decision unit 13b outputs the decision of cameras addition/removal through I/O interface 11 and store the decision in decision history memory 16.

Step S504 to S508 are same as step S304 to S308 in the second exemplary embodiment in FIG. 13.

At step S 509, resource reservation unit 12c informs local terminals 30_1-30_n about the resource arrangements and stores the record of resource arrangements in decision history memory 16.

At step S 510, resource planning unit 15a refers to decision history memory 16 periodically and suggests upgrade in resource capacities at local terminals 30_1-30_n. More specifically, resource planning unit 15a analyses the decisions stored in decision history memory 16 and suggests, based on the analysis, the need to upgrade or rearrange the computing resources, such as CPUs and memories, at the local terminals 30_1-30_n to satisfy the consistent increase in demand for computing resources. It reduces the amount of the data transfer among local terminals 30_1-30_n.

### Effect of Third Exemplary Embodiment

As explained above, distributed surveillance system 300 according to the third exemplary embodiment, in addition to the effect of the first exemplary embodiment, can facilitate optimal resource planning. The reason is that resource planning unit 15a analyses the decisions stored in decision history memory 16 and suggests, based on the analysis, the need to upgrade the computing resources.

The resource optimization leads to efficient operations and reduction in operational costs. Distributed surveillance system 300 ensures real time detection of unusual events in surveillance video with minimum costs and copes with the changes in resource requirements over time.

### Fourth Exemplary Embodiment

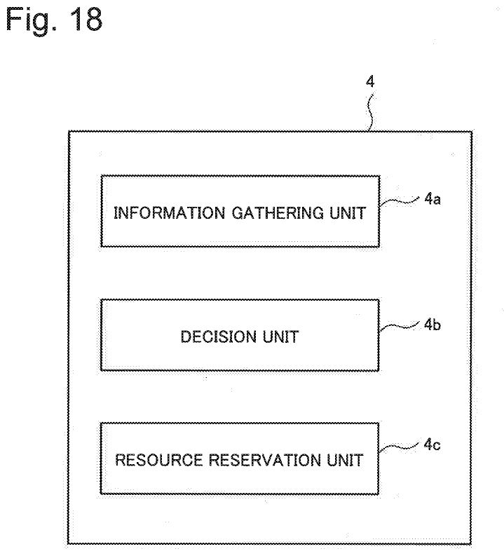

FIG. 18 shows the configuration of centralized control server 4 according to a fourth exemplary embodiment of the present invention. As shown in FIG. 18, centralized control server 4 includes information gathering unit 4a, decision unit 4b and resource reservation unit 4c. Centralized control server 4 is communicatively coupled with a plurality of local terminals which share their resources among them.

Information gathering unit 4a gathers information including current available computing resources and weight values from the plurality of local terminals, the weight value representing current processing demand at the local terminal.

Decision unit 4b calculates a resource requirement at each local terminal based on the weight value thereof, and calculates a gap between the resource requirement calculated and the current available computing resource gathered with the information gathering unit at each local terminal.

Resource reservation unit 4c reserves an additional computing resource for a local terminal having a widest gap among the plurality of local terminals from another local terminal with a narrowest gap among the plurality of local terminals.

This exemplary embodiment can allocate the resources of terminals so as to use the resources efficiently among terminals. The reason is that resource reservation unit 4c reserves an additional computing resource for a local terminal having a widest gap among the plurality of local terminals from another local terminal with a narrowest gap among the plurality of local terminals.

### (Information Processing Apparatus)

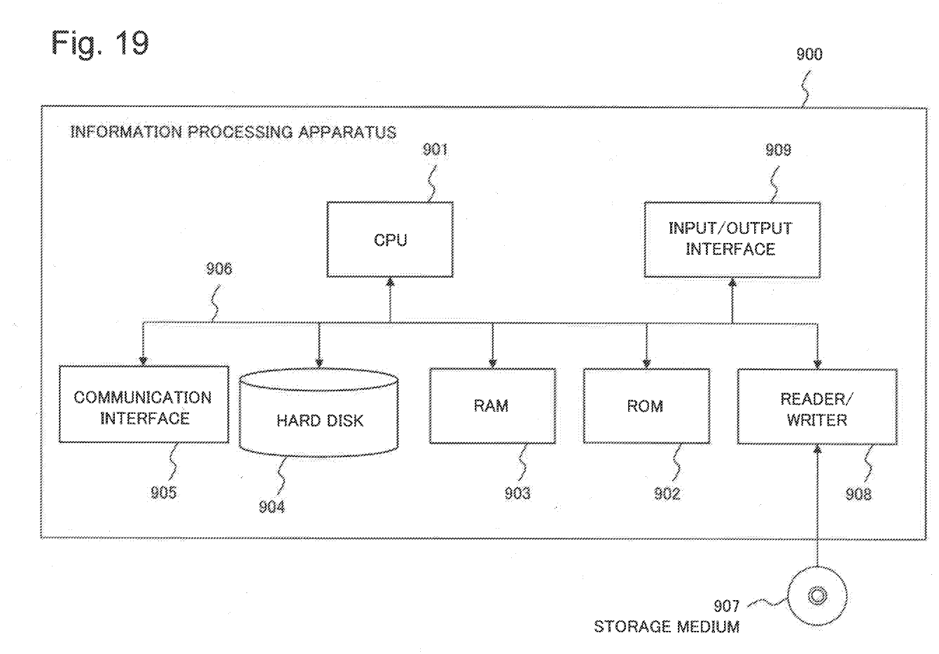

FIG. 19 illustrates, by way of example, a configuration of an information processing apparatus 900 (computer) which can implement a distributed surveillance system (and included server and local terminals) relevant to an exemplary embodiment of the present invention. In other words, FIG. 19 illustrates a configuration of a computer (information processing apparatus) capable of implementing the system, such as, in FIGS. 1, 8, 15 representing a hardware environment where the individual functions in the above-described exemplary embodiments can be implemented. In FIG. 19, directions of arrows is an example, do not limit the flow of data or signals.

The information processing apparatus 900 illustrated in FIG. 19 includes the following as components:

### CPU 901 (Central_Processing_Unit);

### ROM 902 (Read Only Memory);

### RAM 903 (Random Access Memory);

Hard disk 904 (storage device);
Communication interface 905 to an external device (Interface: hereinafter called “I/F”);
Reader/writer 908 capable of reading and writing data stored in a storage medium 907 such as CD-ROM (Compact_Disc_Read_Only_Memory); and
Input/output interface 909.

The information processing apparatus 900 is a general computer where these components are connected via a bus 906 (communication line).

The present invention explained with the above-described exemplary embodiments as examples is accomplished by providing the information processing apparatus 900 illustrated in FIG. 19 with a computer program which is capable of implementing the functions illustrated in the block diagrams (FIGS. 1-4, 8-9, 11-12, 15-16, 18) or the flowcharts (FIGS. 6-7, 13-14, 17) referenced in the explanation of these embodiments, and then by reading the computer program into the CPU 901 in such hardware, interpreting it, and executing it. The computer program provided to the apparatus can be stored in a volatile readable and writable storage memory (RAM 903) or in a non-volatile storage device such as the hard disk 904.

In addition, in the case described above, general procedures can now be used to provide the computer program to such hardware. These procedures include, for example, installing the computer program into the apparatus via any of various storage medium 907 such as CD-ROM, or downloading it from an external source via communication lines such as the Internet. In these cases, the present invention can be seen as being composed of codes forming such computer program or being composed of the storage medium 907 storing the codes.

The previous description of the embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents. Further, it is noted that the inventor's intent is to retain all equivalents of the claimed invention even if the claims are amended during prosecution.

### REFERENCE SIGNS LIST

1: centralized control server
2: network
3_1, 3_2, 3_3, . . . 3_n: local terminals
4: centralized control server
4a : information gathering unit
4b : decision unit
4c : resource reservation unit
10: centralized control server
11: I/O interface
12: control unit
12a : information gathering unit
12b : decision unit
12c : resource reservation unit
13: control unit
13a : information gathering unit
13b : decision unit
14: event memory
14a : event information table
15a : resource planning unit
16: decision history memory
31: camera
32: local network
33: weight assignment unit
33a : workload estimation unit
33b : frame pre-analysis unit
33c : workload prediction unit
33d : support sensory unit
33e : failure detection unit
33f : weight memory
35: analysis unit
36: event information memory
37: I/O interface
38: weight assignment unit
38a : camera detection unit
100: distributed surveillance system
200: distributed surveillance system
300: distributed surveillance system
900: information processing apparatus
901: CPU
902: ROM
903: RAM
904: hard disk
905: communication interface
906: bus
907: storage medium
908: reader/writer
909: input/output interface

What is claimed is:

1. A control server communicatively coupled with a plurality of local terminals, comprising:
a memory, and
one or more processors functioning as:
an information gathering unit configured to gather information including current available computing resources and weight values from the plurality of local terminals, the weight value representing current processing demand at the local terminal;
a decision unit configured to calculate a resource requirement at each local terminal based on the weight value thereof, and calculate a gap between the resource requirement calculated and the current available computing resource gathered with the information gathering unit at each local terminal; and
a resource reservation unit configured to reserve an additional computing resource for a local terminal having a widest gap among the plurality of local terminals from another local terminal with a narrowest gap among the plurality of local terminals.

2. The server according to claim 1, further comprising:
an event memory configured to store event information relating events held at nearby locations of the plurality of local terminals, wherein,
the decision unit calculates a required number of cameras to add or remove at each of the plurality of local terminal by referring to corresponding event information stored in the event memory, and outputs the required number of cameras to add or remove to the corresponding local terminal.

3. The server according to claim 1, further comprising:
a decision history memory configured to store information regarding decisions made by the decision unit; and
a resource planning unit configured to analyze the information regarding decisions stored in the decision history memory, determine whether or not a reallocation of the computing resource is needed at each of the plurality of local terminals, and output a message suggesting a reallocation to a local terminal at which the upgrade is determined to be needed.

4. A local terminal communicatively coupled with a control server, comprising:
a weight assignment unit configured to decide a criticality level by monitoring a location allocated to the local terminal and assign a weight value of the local terminal based on the criticality level; and
an analysis unit configured to analyze result of the monitoring by using computing resources assigned based on the weight value and detect an event therein to generate an alarm according to the severity of the event.

5. The local terminal according to claim 4, wherein the weight assignment unit comprises,
a workload estimation unit configured to estimate near future workload based on past workload patterns and the weight value.

6. The local terminal according to claim 4, wherein the weight assignment unit further comprises,
a support sensory unit configured to sense the location using at least one support sensor and detect anomalies thereat.

7. The local terminal according to claim 4, further comprising,
a plurality of cameras that tracks the location for the monitoring, wherein the weight assignment unit further comprises a camera detection unit configured to monitor number of the cameras and detecting change of the number.

8-9. (canceled)

10. A computer-readable storage medium storing surveillance program for a control server communicatively coupled with a plurality of local terminals to perform processes, the processes comprising:
gathering information including current available computing resources and weight values from the plurality of local terminals, the weight value representing current processing demand at the local terminal;
calculating a resource requirement at each local terminal based on the weight value thereof, and calculating a gap between the resource requirement calculated and the current available computing resource gathered with in the information gathering at each local terminal; and
reserving an additional computing resource for a local terminal having a widest gap among the plurality of local terminals from another local terminal with a narrowest gap among the plurality of local terminals.

11. (canceled)

12. A non-transitory computer-readable storage medium storing surveillance program that causes a local terminal communicatively coupled with a control server to perform processes, the processes comprising:
deciding a criticality level by monitoring a location allocated to the local terminal to assign a weight value of the local terminal based on the criticality level; and analyzing result of the monitoring by using computing resources assigned based on the weight value and detects an event therein to generate an alarm according to the severity of the event.

13. The server according to claim 2, further comprising:
a decision history memory configured to store information regarding decisions made by the decision unit; and
a resource planning unit configured to analyze the information regarding decisions stored in the decision history memory , determine whether or not a reallocation of the computing resource is needed at each of the plurality of local terminals, and output a message suggesting a reallocation to a local terminal at which the upgrade is determined to be needed.

14. The local terminal according to claim 5, wherein the weight assignment unit further comprises,
a support sensory unit configured to sense the location using at least one support sensor and detect anomalies thereat.

15. The local terminal according to claim 5, further comprising,
a plurality of cameras that tracks the location for the monitoring, wherein the weight assignment unit further comprises a camera detection unit configured to monitor number of the cameras and detecting change of the number.

16. The local terminal according to claim 6, further comprising,
a plurality of cameras that tracks the location for the monitoring, wherein the weight assignment unit further comprises a camera detection unit configured to monitor number of the cameras and detecting change of the number.
